(19) United States
(12) Patent Application Publication
(10) Pub. No.: US 2023/0330677 A1
(43) Pub. Date: Oct. 19, 2023

(54) DEVICES, SYSTEMS, AND METHODS FOR SAMPLE TUBE PROCESSING

(71) Applicant: SELUX DIAGNOSTICS, INC., Charlestown, MA (US)

(72) Inventors: Matthew Briscoe, Charlestown, MA (US); Mark Mooradian, Charlestown, MA (US); Eric Stern, Charlestown, MA (US)

(73) Assignee: SELUX DIAGNOSTICS, INC., Charlestown, MA (US)

(21) Appl. No.: 18/025,028

(22) PCT Filed: Sep. 8, 2021
(86) PCT No.: PCT/US2021/049340

§ 371 Date: Mar. 7, 2023

Related U.S. Application Data
(60) Provisional application No. 63/075,471, filed on Sep. 8, 2020.

(51) Int. Cl. B01L 3/00; G01N 35/00

(52) U.S. Cl. CPC B01L 3/50825; G01N 35/0099; B01L 2200/0689; B01L 2200/087; B01L 2300/042; B01L 2300/0858; B01L 2300/123; G01N 2035/00752; G01N 2035/0405

(57) ABSTRACT

The present disclosure relates generally to devices, systems, and methods for sample tube processing and more specifically to antimicrobial susceptibility testing, including automated systems capable of separating viable microbes from positive blood cultures. In an aspect, a sample tube may include a container comprising an open first end, a closed second end, and a tubular wall extending substantially along a longitudinal axis of the container. A protrusion may extend radially from an external surface of the tubular wall. A cap may be reversibly coupled to the first end of the container. The cap may include an interface ring having a top side, an underside, and a central axis therethrough. A skirt portion may extend from the underside substantially parallel with the central axis. A sealing wall may extend from the underside. A channel may be between the skirt portion and the sealing wall configured to reversibly accept the tubular wall.

### PRIORITY

This application claims the benefit of priority under 35 USC § 119 to U.S. Provisional Patent Application Ser. No. 63/075,471, filed Sep. 8, 2020, which is incorporated by reference herein in its entirety and for all purposes.

### FIELD

The present disclosure relates generally to devices, systems, and methods for sample tube processing and more specifically to antimicrobial susceptibility testing, including automated systems capable of separating viable microbes from positive blood cultures.

### BACKGROUND

There is a demand for faster antimicrobial susceptibility test (AST) results to improve infectious diseases patient care. This may be most acute in the case of bacteremic and/or septicemic patients, where AST results often lag confirmation of microbial growth in blood culture (“blood culture positive”) as well as microbial identification (ID) by, for example, two days. Because antibiotic therapies are rarely personalized for patients before AST results are available, current standards-of-care may overutilize broad-spectrum antibiotics. This paradigm may undesirably affect patients because of the side-effects of these potent chemotherapies. Additionally, public health may be at risk because of the evolutionary pressure these antibiotics place on microbes to evolve resistance.

To decrease the time needed for AST results for bacteremic and septicemic patients, it may be effective to perform AST directly from positive blood culture bottles. Traditionally, AST may only be performed from isolated microbial colonies on agar plates (e.g., petri dishes), which may require an overnight incubation, thereby adding significant time (e.g., a day) to the AST process. To perform AST directly from positive blood cultures it may be necessary to separate microbes from components in the blood culture bottles that might impact AST results, e.g., including mammalian cells and cell fragments, soluble inhibitory species (drugs, cationic peptides, etc.), resins, or the like. Importantly, this process should minimally impact microbial viability, which should not be altered to achieve accurate AST. To maximize speed and minimize user-to-user variation, this sepatation procedure may be automated.

Systems for sample tube processing may be limited in the number of samples to process in a cycle, e.g., one sample per cycle. Such processing systems may require extensive processing time, e.g., about six hours to about eight hours or more. Such limitations may allow for the processing of two or fewer samples per system per day under user operation. Further still, user-operated systems include the risk of user error, user-to-user variation, and sample contamination. Automating sample processing in place of at least a portion of user operated sample processing in clinical laboratories may improve accuracy of results, increase productivity, decrease errors, and/or decrease cost. It is with these and other considerations that the present disclosure is useful.

### SUMMARY

In an aspect of the present disclosure, a sample tube may include a container comprising an open first end, a closed second end, and a tubular wall extending substantially along a longitudinal axis of the container. A protrusion may extend radially from an external surface of the tubular wall. A cap may be reversibly coupled to the first end of the container. The cap may include an interface ring having a top side, an underside, and a central axis therethrough. A skirt portion may extend from the underside substantially parallel with the central axis. The skirt portion may have an outer diameter smaller than an outer diameter of the interface ring. A sealing wall may extend from the underside. The sealing wall may be radially within the skirt portion and the sealing wall extending through the central axis. A channel may be between the skirt portion and the sealing wall configured to reversibly accept the tubular wall.

In various embodiments described herein, the sealing wall may further include a first portion extending from the underside of the interface ring substantially parallel with the central axis. A second portion may extend from the first portion away from the underside to a bend extending radially toward the central axis and extending toward the underside. A third portion may extend from the bend toward the interface ring and may extend substantially transverse with the central axis thereby forming a cavity radially within the sealing wall coincident with the central axis. The first portion of the sealing wall may engage an inner surface of the tubular wall when the cap is coupled to the container such that a substantially airtight seal is formed between the sealing wall and the tubular wall. The channel may extend into the interface ring toward the top side of the interface ring. The skirt portion may have a radially flared end having an outer diameter larger than a remainder of the skirt portion. The top side of the interface ring may further include an outer ring portion. An inner ring portion may be radially internal to the outer ring portion. The internal ring portion may be coupled to the outer ring portion by a plurality of ribs arrayed about the central axis. A lifting surface may be on the underside of the interface ring that is substantially transverse with the central axis and is disposed radially external to the skirt portion.

In an aspect, a sample tube manipulation system may include a tray comprising a tray plane and a sample cavity extending normal to the tray plane. A plate may extend parallel with the tray plane. The plate may be moveable between an unlocked configuration and a locked configuration. A sample tube may include a container having a protrusion extending radially from an external surface of a tubular wall of the container and a cap reversibly coupled to an open end of the container. The sample tube may be configured to be reversibly disposed within the sample cavity. A pair of arms may each have a first end and a second end. The pair of arms may be configured to reversibly engage the cap. Each arm may include a cavity. Each cavity may have a first radial surface substantially matching a radius of the cap. Each arm may include a substantially radially extending finger at the second end of the arm.

In various embodiments described herein, the first radial surface may interface with an outer surface of the cap. The finger may interface with an underside of the cap when each of the arms are in an engaged configuration. The protrusion may have an outer diameter larger than a diameter of the sample cavity. When the sample tube is disposed within the sample cavity and the plate is in the locked configuration, the plate may be disposed between the protrusion and an open end of the container. When the pair of arms are engaged with the cap, the cap may be radially compressed against the tubular wall such that moving the pair of arms substantially normal to the tray plane while engaging the cap may translate the entirety of the sample tube. The cavity of each of the pair of arms may include a first portion at the first radial surface. The first portion may include a height that is at least 50% larger than a height of an interface ring of the cap. The first portion may include a substantially transverse surface defining an end of the first portion that is towards the first end of each arm. The transverse surface may be configured to interface with at least a portion of a top surface of the cap. The cap and container of the sample may be configured to reversibly couple to each other via movement of the pair of arms normal to the tray plane when the pair of arms are engaged with the cap, the sample tube is disposed within the sample cavity, and the plate is in the locked configuration. The cavity of each arm may include a second radial surface disposed adjacent to the first radial surface. The second radial surface may have a radius that is different than the radius of the cap.

In various embodiments, a method of processing a sample using a system herein may include providing the first sample tube and a second sample tube to the tray. The first cap of the first sample tube may be engaged with the pair of arms. The first sample tube may be transferred with the pair of arms to a centrifuge. The first sample tube may be subjected to a first centrifugation. The first sample tube may be transferred to the tray with the pair of arms engaging the first cap of the first sample tube. The plate may be locked into the locked configuration. The first cap may be decoupled from the first sample tube with the arms engaging the first cap. A supernatant may be transferred out from the first sample tube to a second sample tube containing a lyse. A portion of the supernatant may be lysed in the second sample tube. The pair of arms may be engaged with a second cap. The second cap may be coupled to the second sample tube. The second sample tube may be transferred to the centrifuge with the pair of arms engaging the second cap of the second sample tube. The second sample tube may be subjected to a second centrifugation. The pair of arms may be engaged with the second cap. The second sample tube may be transferred to the tray with the pair of arms engaging the second cap of the second sample tube. The plate may be locked into the locked configuration. The second cap may be decoupled from the second sample tube. A saline solution may be transferred to the second sample tube. An optical density of a fluid may be measured of the second sample tube. Coupling the second cap to the second sample tube, transferring the second sample tube to the centrifuge with the pair of arms engaging the second cap of the second sample tube, subjecting the second sample tube to the second centrifugation, engaging the pair of arms with the second cap, transferring the second sample tube to the tray with the pair of arms engaging the second cap of the second sample tube, locking the plate into the locked configuration, decoupling the second cap from the second sample tube, transferring the saline solution to the second sample tube, and measuring an optical density of the fluid of the second sample tube steps may be optionally repeated. The fluid of the second sample tube may be transferred to an inoculum tube. The fluid of the inoculum tube may be diluted.

In an aspect, a method of processing a sample may include substantially locking a first container with respect to a first portion of a tray. A cap may be removed from the first container. A fluid may be withdrawn from a second container located at a second portion of the tray. The fluid may be added from the second container to the first container. The cap may be installed onto the first container.

In various embodiments, the cap may be radially compressed with a pair of arms. The first container may be unlocked with respect to the first portion of the tray. The first container may be removed from the first portion of the tray. The cap may be axially compressed with a pair of arms.

In an aspect, a method of processing a sample using a system described herein may include providing the first sample tube and a second sample tube to the tray. The first cap of the first sample tube may be engaged with the pair of arms. The first sample tube with the pair of arms may be transferred to a centrifuge. The first sample tube may be subjected to a first centrifugation. The first sample tube may be transferred to the tray with the pair of arms engaging the first cap of the first sample tube. The plate may be locked into the locked configuration. The first cap may be decoupled from the first sample tube with the arms engaging the first cap. A supernatant may be transferred out from the first sample tube to a second sample tube containing a lyse. A portion of the supernatant may be lysed in the second sample tube. The pair of arms may be engaged with a second cap. The second cap may be coupled to the second sample tube. The second sample tube may be transferred to the centrifuge with the pair of arms engaging the second cap of the second sample tube. The second sample tube may be subjected to a second centrifugation. The pair of arms may be engaged with the second cap. The second sample tube may be transferred to the tray with the pair of arms engaging the second cap of the second sample tube. The plate may be locked into the locked configuration. The second cap may be decoupled from the second sample tube. All supernatant may be transferred from second sample tube to waste. A saline solution may be transferred to the second sample tube. The method may optionally repeat at least one of the steps of coupling the second cap to the second sample tube, transferring the second sample tube to the centrifuge with the pair of arms engaging the second cap of the second sample tube, subjecting the second sample tube to the second centrifugation, engaging the pair of arms with the second cap, transferring the second sample tube to the tray with the pair of arms engaging the second cap of the second sample tube, locking the plate into the locked configuration, decoupling the second cap from the second sample tube, transferring all supernatant from second sample tube to waste, and/or transferring the saline solution to the second sample tube. An optical density of a fluid of the second sample tube may be measured. The fluid of the inoculum tube may be diluted. Measuring an optical density of a fluid of the second sample tube and diluting the fluid in the second sample tube may optionally be repeated until an optimum optical density is achieved. The fluid of the second sample tube may be transferred to an inoculum tube.

In an aspect, a method of processing a sample may include substantially locking a first container containing a positive blood culture with respect to a tray. The first container may be subjected to a first centrifugation. A first cap may be removed from the first container. A supernatant may be transferred out from the first container to a second container containing a lyse. A second cap may be coupled to the second container. The supernatant may be lysed. The second container may be subjected to a second centrifugation. The second cap may be removed from the second container. Supernatant may be transferred from the second container to waste. A saline solution may be transferred to the second container. An optical density of a fluid of the second container may be measured. At least a portion of the fluid of the second container may be transferred out into a third container. At least a portion of the fluid of the third container may be diluted.

In various embodiments, the first cap may be engaged by radially compressing the first cap with a pair of arms. The first container may be substantially locked with respect to the tray with a plate extending between a protrusion of the first container and a top of the first container. The first container may be unlocked with respect to the tray by the plate extending radially away from the first container. The method may include repeating at least one of the steps of subjecting the second container to a second centrifugation, removing the second cap from the second container, transferring all supernatant from second container to waste, and transferring a saline solution to the second container, and coupling the second cap to the second container twice. The second cap may be axially compressed with a pair of arms.

### BRIEF DESCRIPTION OF THE DRAWINGS

Non-limiting embodiments of the present disclosure are described by way of example with reference to the accompanying figures, which are schematic and not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the disclosure. In the figures:

FIG. 1 illustrates a cross-section of a container, according to an embodiment of the present disclosure.

FIG. 2A illustrates a perspective view of a cap, according to an embodiment of the present disclosure.

FIG. 2B illustrates a top view of the cap of FIG. 2A.

FIG. 2C illustrates an elevational view of the cap of FIGS. 2A and 2B coupled to an end of a container, according to an embodiment of the present disclosure.

FIG. 2D illustrates a cross-sectional view of the cap and a portion of the container of FIG. 2C.

FIG. 3A illustrates a pair of arms, according to an embodiment of the present disclosure.

FIG. 3B illustrates a right elevational view of one of the pair of arms of FIG. 3A.

FIG. 4A illustrates a top view of a tray in an unlocked configuration, according to an embodiment of the present disclosure.

FIG. 4B illustrates a top view of the tray of FIG. 4A with a top layer of the tray removed.

FIG. 4C illustrates the tray of FIGS. 4A and 4B in a locked configuration.

FIG. 5A illustrates a perspective view of a pair of arms engaging a sample tube on a tray, according to an embodiment of the present disclosure.

FIG. 5B illustrates a cross-section of the pair of arms engaging the sample tube of FIG. 5A.

FIG. 5C illustrates the pair of arms decoupling the cap from the container of the sample tube of FIGS. 5A and 5B.

FIG. 5D illustrates the pair of arms engaging the sample tube and holding the sample tube out of the tray of FIGS. 5A-5C.

FIG. 5E illustrates the pair of arms about the sample tube of FIGS. 5A-5D.

FIG. 6 illustrates a method of sample tube processing, according to an embodiment of the present disclosure.

FIG. 7 illustrates a method of a user operating a system embodiment of sample tube processing, according to an embodiment of the present disclosure.

### DETAILED DESCRIPTION

The present disclosure is not limited to the particular embodiments described. The terminology used herein is for the purpose of describing particular embodiments only and is not intended to be limiting beyond the scope of the appended claims. Unless otherwise defined, all technical terms used herein have the same meaning as commonly understood by one of ordinary skill in the art to which the disclosure belongs.

Microbial growth in blood can be determined using continuous monitoring blood culture (CMBC) systems that are designed to enable blood to be directly added into culture media, which may be loaded onto CMBCs. When a CMBC determines that a sample is positive for microbial growth, it alerts a user who can then perform assays to analyze a sample, e.g., a positive blood culture sample. A blood culture is a test that checks for foreign invaders like bacteria, yeast, viruses, pathogens, and other microorganisms in blood. These foreign invaders in a bloodstream can be a sign of a blood infection, e.g., a condition known as bacteremia. Assays for analyzing a sample may include, but are not limited to, microbial identification (“ID”), such as by multiplex genetic approaches, matrix-assisted laser desorption ionization mass spectrometry (“MALDI”), and/or biochemical tests, and resistance or susceptibility testing, such as by multiplex genetic approaches, sequencing, and/or phenotypic antimicrobial susceptibility testing (“AST”).

Although embodiments of the present disclosure may be described with specific reference to samples (e.g., blood, blood components, e.g., platelets or the like, cultures, bacteria, a combination thereof, or the like), it should be appreciated that devices and systems herein may be used with a variety samples.

As used herein, the singular forms “a,” “an,” and “the” are intended to include the plural forms as well, unless the context clearly indicates otherwise. The terms “comprises” and/or “comprising,” or “includes” and/or “including” when used herein, specify the presence of stated features, regions, steps, elements and/or components, but do not preclude the presence or addition of one or more other features, regions, integers, steps, operations, elements, components and/or groups thereof.

As used herein, “top” refers to the end of a device or a portion of a device that lies opposing gravitational force along the device when included in a system, and “under” refers to the end of a that lies in the direction of gravitational force along the device when included in a system. However, “top” and/or “under” may be inverted, rotated, or otherwise moved such that their relationship with gravitational force is changed temporarily or permanently within or external to a system.

As used herein, the conjunction “and” includes each of the structures, components, features, or the like, which are so conjoined, unless the context clearly indicates otherwise, and the conjunction “or” includes one or the others of the structures, components, features, or the like, which are so conjoined, singly and in any combination and number, unless the context clearly indicates otherwise.

All numeric values are herein assumed to be modified by the term “about,” whether or not explicitly indicated. The term “about”, in the context of numeric values, generally refers to a range of numbers that one of skill in the art would consider equivalent to the recited value (i.e., having the same function or result). In many instances, the term “about” may include numbers that are rounded to the nearest significant figure. Other uses of the term “about” (i.e., in a context other than numeric values) may be assumed to have their ordinary and customary definition(s), as understood from and consistent with the context of the specification, unless otherwise specified. The recitation of numerical ranges by endpoints includes all numbers within that range, including the endpoints (e.g., 1 to 5 includes 1, 1.5, 2, 2.75, 3, 3.80, 4, and 5).

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

A “sample tube” includes a container, e.g., a collection tube, that may hold a sample for processing, e.g., centrifugal isolation of bacteria from blood by their relative density, lysing, or the like. Capping the container is desirable prior to processing and/or sample tube manipulation to prevent contamination.

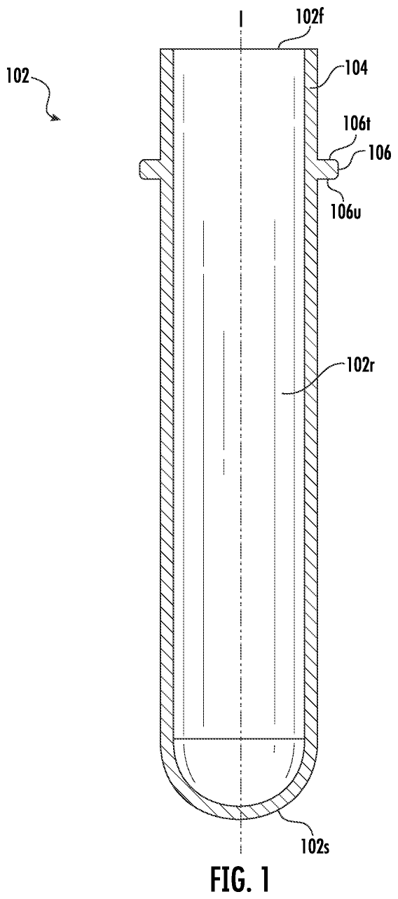

Referring to FIG. 1, a cross-section of an embodiment of a container 102 according to the present disclosure is illustrated having an open first end 102f, a closed second end 102s, and a tubular wall 104 extending substantially along a longitudinal axis [symbol] of the container 102. The tubular wall 104 defines a reservoir 102r between the first end 102f and the second end 102s. A protrusion 106 extends radially from an external surface of the tubular wall 104. The protrusion 106 may annularly extend about the wall 104. The protrusion 106 has a top side 106t and an underside 106u. The underside 106u may act as a stop for the container 102, e.g., when the container 102 is disposed within a sample cavity as will be described. The top side 106t may act as a restraint, preventing removal of the container 102 from a sample cavity when a plate is disposed over the top side 106t, as will be described in further detail below.

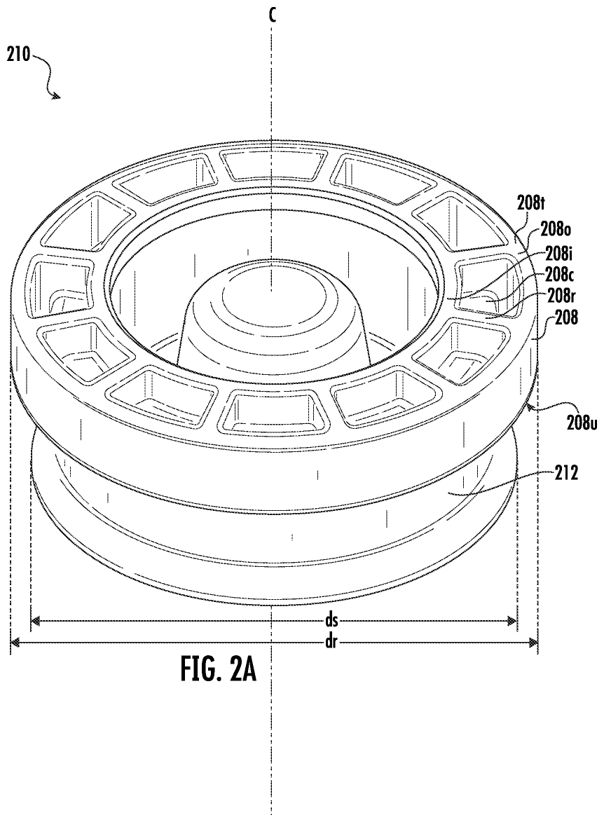

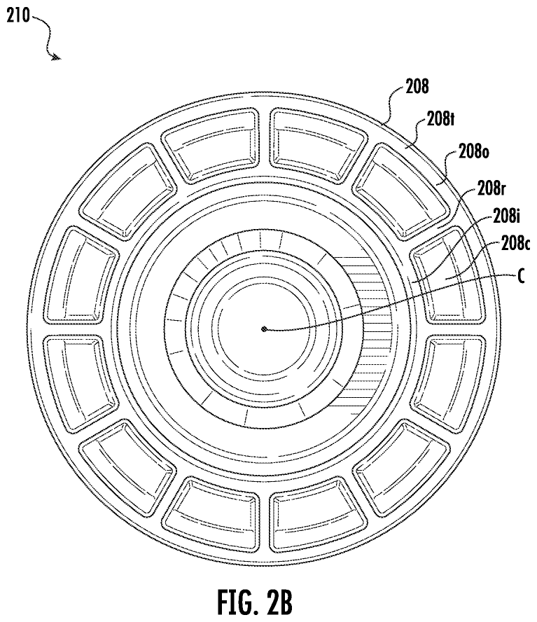

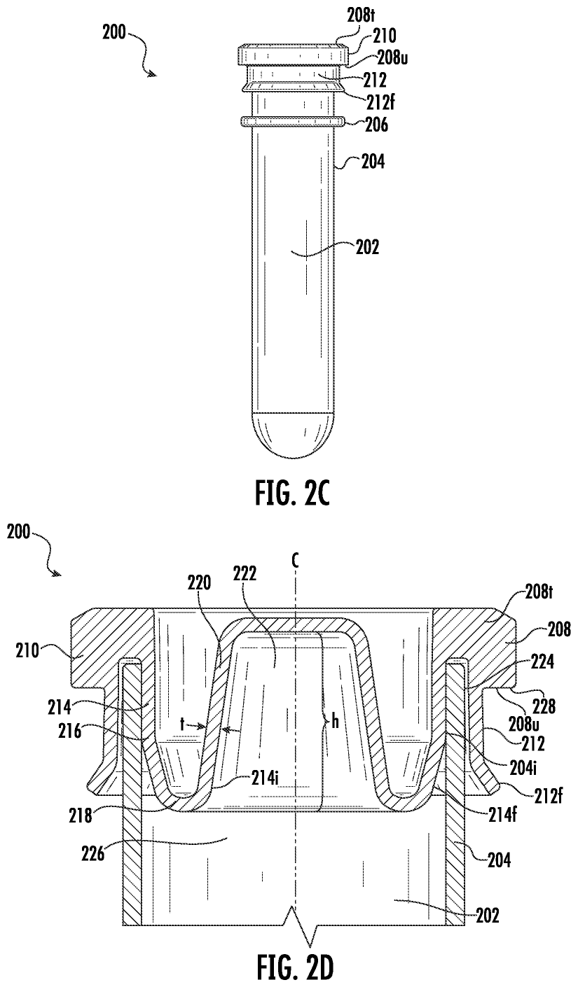

Referring to FIGS. 2A and 2B, an embodiment of a cap 210 according to the present disclosure is illustrated including an interface ring 208 having a top side 208t, an underside 208u, and a central axis c therethrough. The top side 208t of the interface ring 208 includes an outer ring portion 208o and an inner ring portion 208i. The inner ring portion 208i is radially inward with respect to the outer ring portion 208o and is coupled to the outer ring portion 208o by one or more ribs 208r. The ribs 208r are arrayed about the central axis c. Between the ribs 208r are radial cavities 208c. The radial cavities 208c and ribs 208r allow for radial compression of the outer ring portion 208o and/or the inner ring portion 208i when the interface ring 208 is radially compressed. This radial compression may allow for the interface ring 208 to elastically deform such that the interface ring 208 better interfaces with an external gripping body than if the interface ring 208 did not deform. A skirt portion 212 extends from the underside 208u of the interface ring 208 that is substantially parallel with the central axis c. The skirt portion 212 has an outer diameter dₛ smaller than an outer diameter dr of the interface ring 208.

Referring to FIG. 2C, the cap 210 of FIGS. 2A and 2B is illustrated as coupled to a container 202 including a protrusion 206. FIG. 2D illustrates a cross-section of the cap 210 coupled to the container 202. The cap 210 may be reversibly coupled to the tube 202 and is illustrated coupled to the first end 202fof the container 202. The cap 210 includes the interface ring 208 with the top side 208t, the underside 208u, and the central axis c therethrough. A skirt portion 212 extends from the underside 208u of the interface ring 208 about the circumference of the cap 210 and may be substantially parallel to the central axis c. A sealing wall 214 extends from the underside 208u of the interface ring 208. The sealing wall 214 is positioned radially inwardly from the skirt portion 212. The sealing wall 214 continues extending across the cap 210 through the central axis c. The sealing wall 214 includes a first portion 216 extending from the underside 208u of the interface ring 208 substantially parallel with the central axis c. A second portion 218 of the sealing wall 214 extends radially inwardly from the first portion 216 and in a direction away from the underside 208u, to a bend extending radially toward the central axis c and extending toward the underside 208u. A third portion 220 of the sealing wall 214 extends from the bend of the second portion 218 toward the top side 208t of the interface ring 208 and extends substantially transverse with respect to the central axis c, thereby forming a cavity 222 radially within the third portion 220 of the sealing wall 214 coincident with the central axis c. A channel 224 is disposed between the skirt portion 212 and the sealing wall 214. The channel 224 extends into the interface ring 208 substantially parallel with the central axis c in a direction towards the top side 208t of the interface ring 208. The cap 210 may be coupled and decoupled from the container 202 by translating the cap 210 and/or the container 202 along the central axis c with respect to each other, i.e., toward each other to couple and away from each other to decouple. The channel 224 reversibly accepts the tubular wall 204 such that when the tubular wall 204 is disposed with the channel 224, the first portion 216 of the sealing wall 214 engages an inner surface 204i of the tubular wall 204 forming a substantially airtight seal between the sealing wall 214 and the tubular wall 204. The sealing force between the sealing wall 214 and the tubular wall 204 is sufficient enough such that an axial lifting force applied to the cap 210 (i.e., substantially parallel with the central axis c) will lift the sample tube 200, including the cap 210 coupled with the container 202. The sealing wall 214 and the skirt 212 each have a radially flared portion 212f, 214f that is angled away from the channel 224 where the tubular wall 204 is first disposed between the skirt 212 and the sealing wall 214 when coupling to the cap 210. The flared portions 212f, 214f may assist with guiding the tubular wall 204 when disposing the skirt portion 212 and sealing wall 214 about the tubular wall 204 of the container 202 such that the tubular wall 204 engages the channel 224 for sealing with the sealing wall 214. The sealing wall 214, including the first, second, and third portions 216, 218, 220, has a substantially uniform thickness t throughout such that the sealing wall 214 is flexible. Flexibility of the sealing wall 214 may assist with sealing the sealing wall 214 with the tubular wall 204. A substantially uniform thickness t for the first, second, and third portions 216, 218, 220 may increase manufacturability of the cap 210 (e.g., reduced manufacturing cost) compared to a variable thickness t.

With continued reference to FIGS. 2C and 2D, the cavity 222 extends a sealed internal volume 226 of the sample tube 200 with the cap 210 coupled to the container 202. A sample tube 200 with a larger height [symbol] of the cavity 222 has a larger sealed internal volume 226 than a sample tube 200 with a smaller height [symbol] of the cavity 222. As the cap 210 is coupled with the container 202, the sealed internal volume 226 is compressed. As the sealed internal volume 226 is compressed, outward pressure on an internal surface 214i of the sealing wall 214 increases. As outward pressure increases on the internal surface 214i of the sealing wall 214, a force threshold may be reached causing the cap 210 to decouple from the tubular wall 204. As the cavity 222 volume increases (e.g., by increasing the height [symbol] ), compression forces within the sealed internal volume 226 decreases. The cap 210 includes a lifting surface 228 on the underside 208u of the interface ring 208 that is substantially transverse with the central axis c and is disposed radially external to the skirt portion 212. The lifting surface 228 may be engaged by a user or an external body (e.g., arms of a gripper as will be described) to lift the sample tube 200 and/or decouple the cap 210 from the container 202.

Caps described herein are coupled to containers via substantial axial translation of the cap with respect to the container toward each other. These caps are advantageous over screw threaded caps for multiple reasons that are contemplated. For example, a sealing tightness of a screw threaded cap is related to the torque applied during coupling of the cap to the container, which may vary between sample tubes depending on how they were coupled. Additionally, for example, the torque required to decouple a screw threaded cap may be larger than an axial force for decoupling caps described herein. These larger forces may undesirably require larger gripping strength, heavier tools, additional energy, a greater degree of rotational freedom, a larger sized gantry, and/or a more complex gantry. Exemples of materials which may be used to form a cap and/or tube may include, e.g., polypropylene, high density polyethylene (HDPE), thermoplastic polymers such as acrylonitrile butadiene styrene (ABS), or the like.

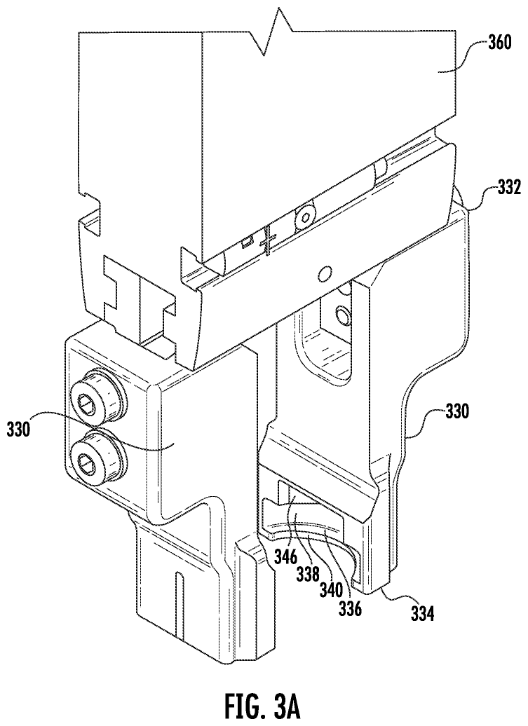

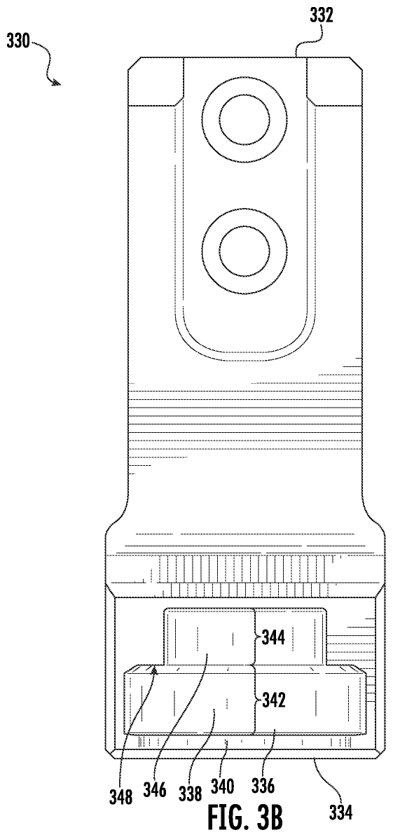

Referring to FIGS. 3A and 3B, an embodiment of a pair of arms 330 according to the present disclosure is illustrated for engaging and manipulating sample tubes, caps, and/or containers. FIG. 3A illustrates the pair of arms 330 mounted to a fixture 360 (e.g., a gantry) and FIG. 3B illustrates a right view of an arm 330. Each arm 330 has a first end 332 and a second end 334. Each arm 330 includes a cavity 336 within a side of each arm 330 that substantially faces the other arm 330. Each cavity 336 has a first radial surface 338 that substantially matches a radius of a cap (e.g., an interface ring of a cap). A finger 340 at the second end of each arm 330 extends in a substantially radial direction toward the other arm 330. The cavity 336 includes a first portion 342 at the first radial surface 338 and a second portion 344 adjacent the first portion 342 towards the first end 332. The second portion 344 of the cavity 336 has a second radial surface 346 with a radius that is different than the radius of the first radial surface 338 (e.g., smaller than the radius for the first radial surface 338 for interfacing with a smaller sample tube). The first portion 342 of the cavity 336 has a substantially transverse surface 348 defining an end of the first portion 342 that is towards the first end 332 of each arm 330. The transverse surface 348 is configured to interface with at least a portion of a top surface of a cap (e.g., for coupling a cap to a container) as will be described. The first portion 342 of each cavity 336 has a height (e.g., between the finger 340 and the transverse surface 348) that may be at least 50% larger than a height of an interface ring of a cap.

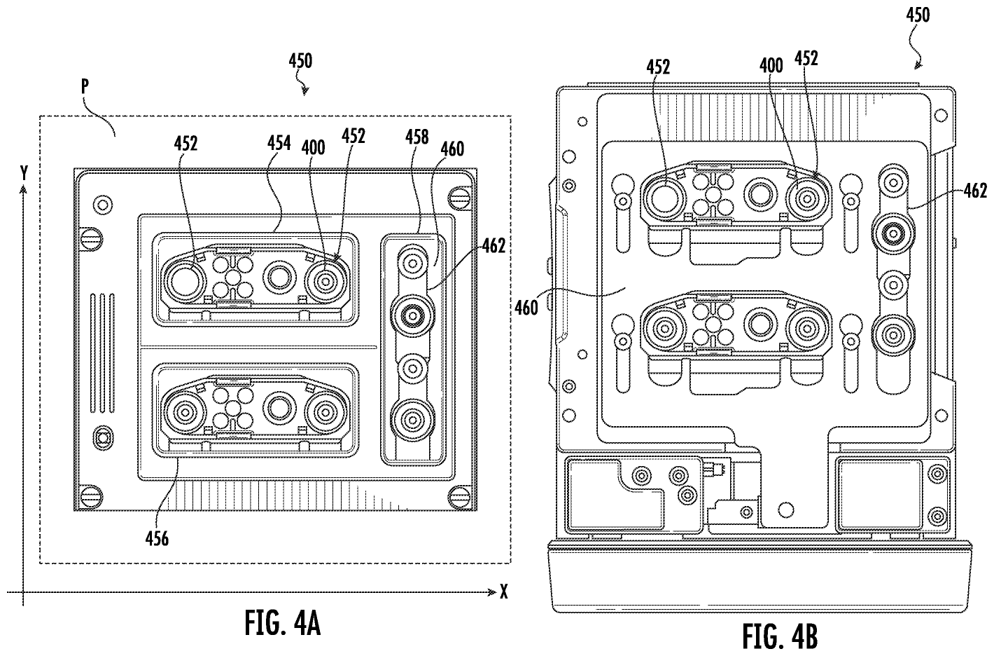

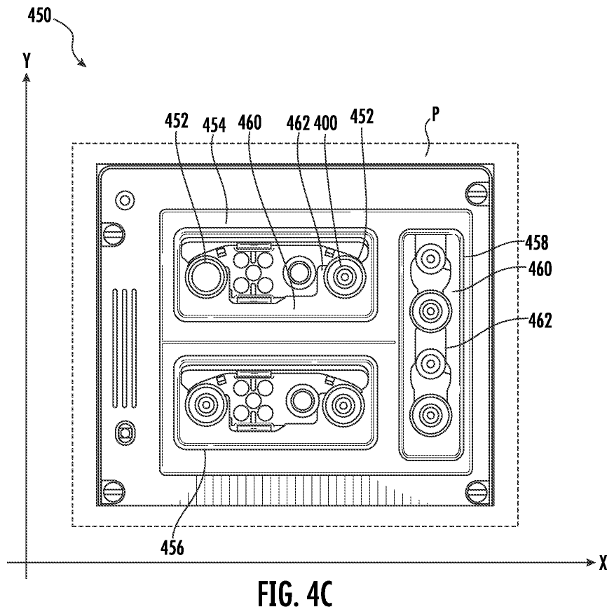

Referring to FIGS. 4A through 4C, an embodiment of a tray 450 according to the present disclosure is illustrated including a plane [symbol] along an x-y axis of the tray 450. The tray 450 includes a sample cavity 452 that extends normal to the tray plane [symbol] . The sample cavity 452 can accommodate a sample tube 400. A tray 450 may have multiple sample cavities 452, which may be grouped into multiple portions of the tray, e.g., a first portion 454 of sample cavities 452, a second portion 456 of sample cavities 452, and a third portion 458 of sample cavities 452. The groups 454, 456, 458 may each correspond to a different set of sample tubes 400, additives, a kit, or the like. A plate 454 extends substantially parallel with the plane [symbol] that is moveable between an unlocked configuration, as illustrated in FIGS. 4A and 4B, and a locked configuration, as illustrated in FIG. 4C. In the unlocked configuration, edges 462 of the plate 460 are positioned away from the sample tubes 400. In the unlocked configuration, the sample tubes 400 may be moved into or out of the sample cavities 452 of the tray 450. In the locked configuration, the plate 460 is positioned over protrusions of the sample tubes 400 (e.g., between the protrusion 206 and cap 200 of FIG. 2C). With the plate 460 in the locked configuration, the container of each sample tube 400 cannot be removed from the sample cavities 452 because the top side surface of the protrusion of the container would collide with an underside of the plate 460. However, a cap of the sample tubes 400 may be coupled and decoupled from the container of the sample tubes 400 in the locked configuration as will be described. Sample cavities 452 throughout the tray may be used during operation to temporarily hold one or more fluids and/or caps of the sample tubes 400 if a user or operating arms need to decap two or more tubes while processing. For example, if a first sample tube 400 and a second sample tube 400 both need to be accessed for a processing step, a sample cavity 452 may allow the operation arms to decap the first tube 400 and temporarily discard the first cap of the first sample tube 400 onto the sample cavity 452 (that may or may not contain a third sample tube 400) so that the arms may then engage a second cap of the second sample tube 400 to also be decapped.

Systems and methods described herein may be associated with consumables for automating the separation of intact microbes from positive blood culture bottles for performing downstream AST and, potentially, other diagnostic testing.

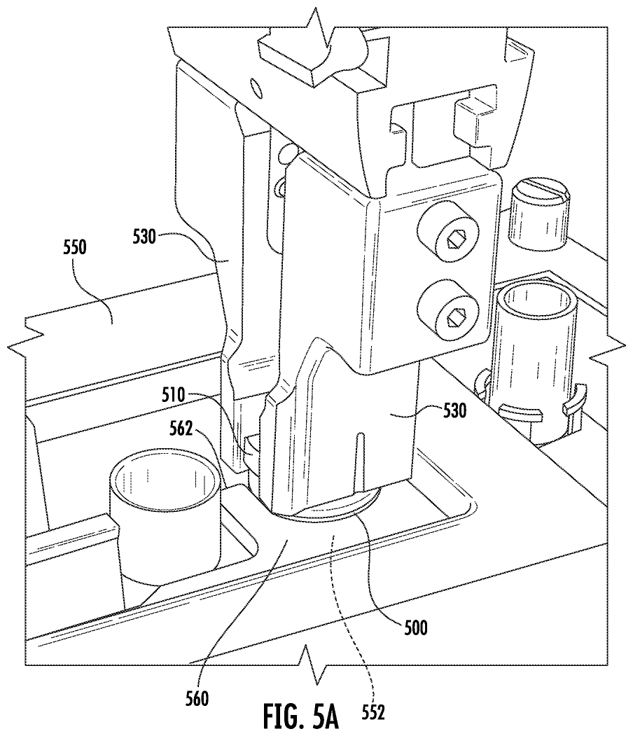

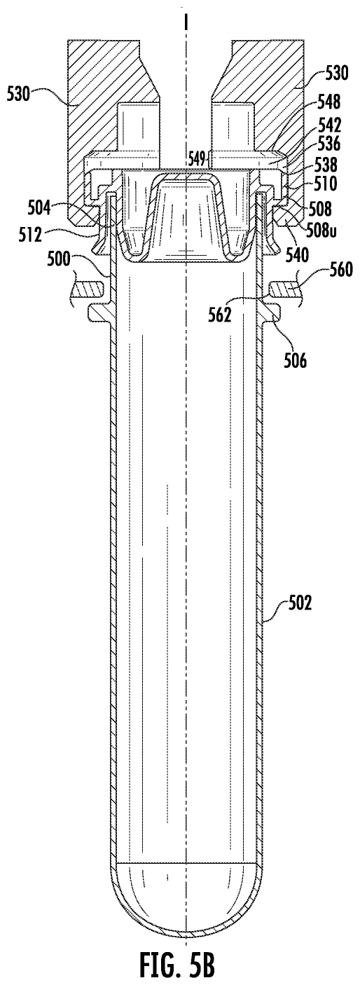

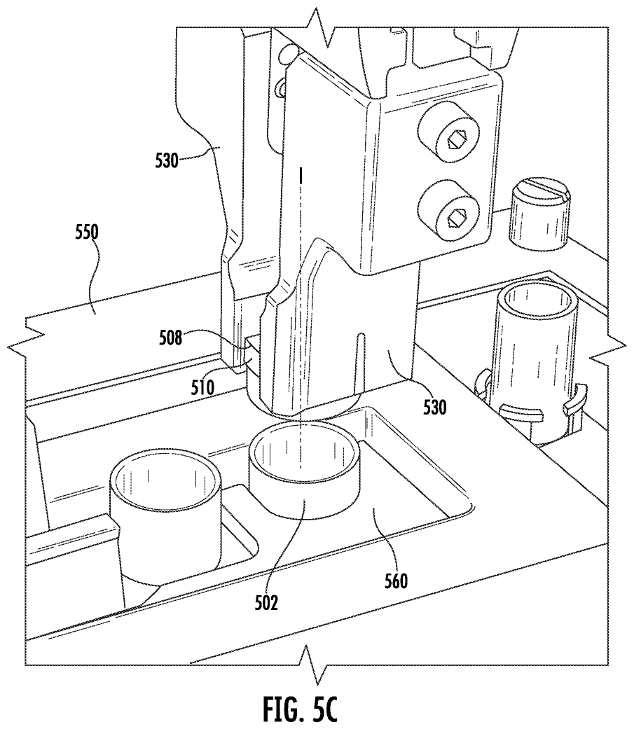

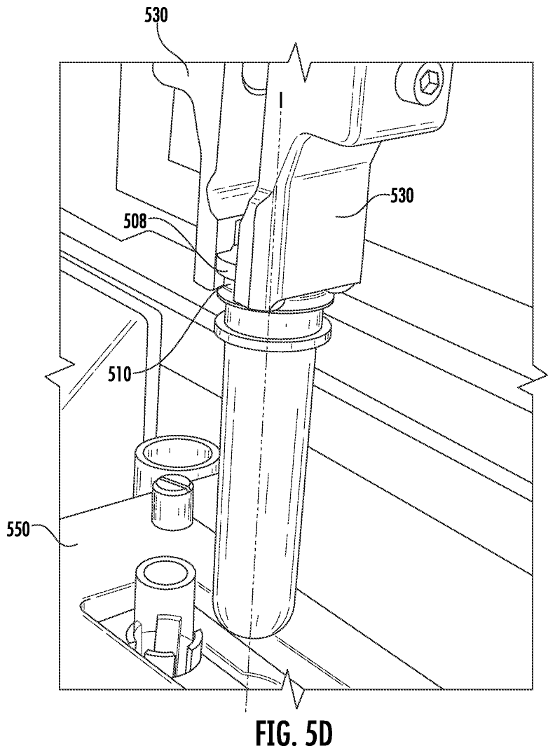

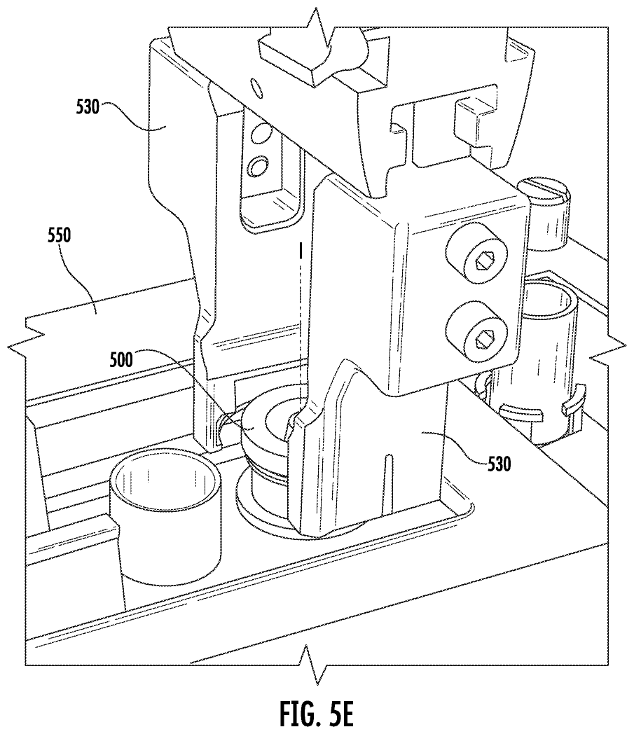

Referring to FIGS. 5A and 5B, an embodiment of a pair of arms 530 engaging a sample tube 500 within a tray 550 according to the present disclosure is illustrated. The sample tube 500 is disposed within a sample cavity 552 of the tray 550 with the plate 560 in the locked configuration with an edge 562 of the tray 550 extended over a protrusion 506 of a container 502. The plate 560 is extending between the protrusion 506 and a cap 510 of the sample tube 500 such that the sample tube 500 is substantially locked within the tray 550. The pair of arms 530 are radially disposed about and engaging the sample tube 550 such that an interface ring 508 of the cap 510 is within a first portion 542 of a cavity 536 of the arms 530. The first portion 542 includes a first radial surface 538 that substantially matches the radius of the interface ring 508. In an engaged configuration, a finger 540 of each arm 530 extends towards a longitudinal axis [symbol] of the system and substantially parallel with an underside 508u of the interface ring 508.

In various embodiments described herein, the engaged configuration of the arms 530 with the sample tube 500 may be used to manipulate and/or move the sample tube 500 with respect to the tray 500 or the cap 510 with respect to the container 502. In the engaged configuration, the sample tube 500 may have the first radial surface 538 of the arms 530 in substantial contact with the interface ring 508. In the engaged configuration, the arms 530 may be radially compressing the interface ring 508 toward the longitudinal axis [symbol] such that the radial compression force transfers to a sensor of an arm or arms 530 or gantry, indicating that the interface ring 508 is engaging the arms 530. This detected force by the sensor may be used to control the arms 530 such that the interface ring 508 is adequately engaged for manipulation without overcompressing (which may undesirably elastically or plastically deform the cap 510 and/or the container 502 or affect the seal between the cap 510 and the container 502 for example) or undercompressing (which may undesirably not provide adequate engagement between the arms 530 and the cap 510 and/or the container 502 for cap 510 or tube 500 manipulation for example). Additionally or in the alternative, the arms 530 may be in the engaged configuration with the first radial surface 538 not in contact with the interface ring 508, but with the interface ring 508 positioned within the first portion 542 of the cavity 536 with the fingers 540 of the arms 530 extending substantially parallel with the underside 508u of the interface ring 508. Additionally or in the alternative, the arms 530 may be in the engaged configuration with the first portion 542 of the cavity 536 having a height 549 of the first portion 542 that is a distance between the interface ring 508 and a transverse surface 548 parallel with the longitudinal axis [symbol] . The height 549 of the first portion 542 may extend the volume of the first portion 542 of the cavity 536 such that there is enough tolerance for the arms 530 to engage the interface ring 508 within the cavity 536 reliably (e.g., the height 549 may be about 2 mm, about 5.5 mm, or the like). The additional volume of the first portion 542 defined by the height 549 may be used to “overdrive” the cap 510 with the tube 502 by moving the arms 530 while in the engaged configuration substantially parallel with the longitudinal axis [symbol] (i.e., axially with the longitudinal axis [symbol] ) such that the transverse surface 548 presses against the interface ring 508 for an axial overdrive distance. Overdriving the cap 510 may be performed to couple the cap 510 to the container 502. An exemple of an overdrive distance that the arms 530 may apply to the cap 510 is about 2 mm. A skirt 512 of the cap 510 extends from the interface ring 508 along the container wall 504 that may assist with preventing undesirable contact between the finger 540 of each arm 530 and the container 502, thereby reducing contamination concerns of the system and/or between sample tubes 500. Varying radial compression force between the arms 530 and the interface ring 508 may determine system function as the arms 530 move along the longitudinal axis [symbol] . For example, with the arms 530 in the engaged configuration in contact with the interface ring 508 but without a radial compression force would not translate compressional force from the interface ring 508 to the container wall 504. Movement of the arms 530 in this configuration away from the container 502 along the longitudinal axis [symbol] moves the fingers 540 against the underside 508u of the interface ring 508, moving the cap 510 along the longitudinal axis [symbol] away from the container 502 with a locking plate 560 in the locked configuration (e.g., as illustrated in FIG. 5C) thereby decoupling the cap 510 from the container 502. For another example, with the arms 530 in the engaged configuration and with a radial compression force of, e.g., up to about 60 N, the interface ring 508 may be compressed for manipulation of the cap 510 and possibly the container 502 (i.e., manipulation of both the cap 510 and the container if not locked by the locking plate 560). Movement of the arms 530 in this configuration away from the tray 550 (e.g., as illustrated in FIG. 5D) along the longitudinal axis [symbol] moves the compressed interface ring 508 and container 502 together, thereby moving the cap 510 and container 502 substantially along the longitudinal axis [symbol] (e.g., out of a sample cavity 552 of a tray 550 or into a sample cavity 552 of a tray 550 if in reverse direction substantially along the longitudinal axis [symbol] ) with the tray 550 in an unlocked configuration. A cap 510 may be sealingly engaged with a container 502 with enough friction such that the cap 510 may be manipulated to also manipulate the engaged container 502, which may or may not include fluid therein.

With reference to FIG. 5E, arms 530 of a system prior to or thereafter being in an engaged configuration may be radially spaced away from the longitudinal axis [symbol] and the sample tube 500 in an unengaged configuration of the arms 530. With the arms 530 in the unengaged configuration, the arms 530 can be moved toward and away from the tray 550 parallel with the longitudinal axis [symbol] without manipulating or moving the sample tube 500. As the arms 530 move radially into or out of contact with the sample tube 500, one or more sensors of the system may measure a radial force of the arms 530 contacting the sample tube 500, e.g., to detect when the arms 530 contact the sample tube 500, when enough radial force is applied to the sample tube 500 for manipulation or movement, or the like. Such manipulation, movement, assembly, disassembly, coupling, decoupling, capping, or uncapping with the arms 530 and sample tube 500 may be performed with minimal radial/lateral movement or forces with respect to the longitudinal axis [symbol] and such operations are instead performed in a substantially axial or parallel orientation with respect to the longitudinal axis [symbol] . Axial movement of the arms 530 for moving, assembling, disassembling, coupling, decoupling, capping, or uncapping a sample tube 500 may impart a force on the cap 510 and/or the container 502 of the sample tube 500 of, e.g., about 5 N.

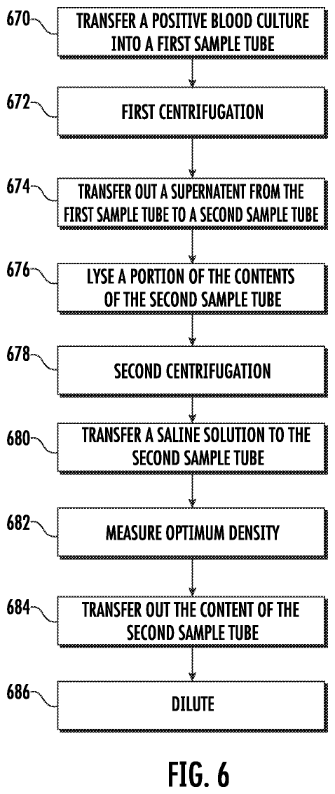

Referring to FIG. 6, an embodiment of a method of sample tube processing according to the present disclosure is illustrated. The method includes transferring 670 a positive blood culture (e.g., a crude sample fluid) into a first sample tube. The positive blood culture may include bacteria, yeast, other microorganisms, or otherwise be diseased. The sample tube may include a media (e.g., a growth media, a saline solution, or the like including combinations thereof). Although this embodiment and others discussed throughout this disclosure mention blood, other fluids, semi-fluids, and/or solids may be used instead or in addition to blood, (e.g., a component of blood, synovial material, pleural material, pericardial material, other bodily fluids, other organic media, or the like). A first centrifugation 672 is performed with the first sample tube. The first centrifugation 672 may be, e.g., at about 500 g centrifugal force or the like. The first centrifugation 672 may substantially separate out portions of the contents of the first sample tube, e.g., blood debris, blood cells, or other blood contents from bacteria. A supernatent of the first sample tube is transferred 674 out of the first sample tube to a second sample tube that may contain a lysis buffer or to which a lysis buffer is added. A portion of the contents of the second sample tube is lysed 676, e.g., platelets of the second sample tube are substantially lysed 676 while bacteria is substantially not lysed. A second centrifugation 678 is performed with the second sample tube. The second centrifugation 678 may be, e.g., at about 1,750 g centrifugal force or the like. The second centrifugation 678 may create a solid or semi-solid precipitate or pellet within the second sample tube (e.g., resulting in a clarified sample). The clarified sample may be further washed with, e.g., saline solution that may be transferred 680 to the second sample tube and/or subject to further centrifugation. The content of the second sample tube is measured 682 for optical density. The second centrifugation 678, transferring 680, and measuring 682 steps may be repeated (e.g., three times) until at least a desired optical density is achieved. The content of the second sample tube is transferred 684 out of the second sample tube (e.g., into an inoculum tube, which may or may not include a culture broth or other media) or out of the system but within the second sample tube. The content of the second sample tube is diluted 686 until at least a desired concentration of the content is achieved (e.g., resulting in a concentrated sample) for further processing and/or analyzing (e.g., AST processing). An embodiment of a method of processing a sample using the devices or systems described herein may include substantially locking a first container with respect to a first portion of a tray. A cap may be removed from the first container. A fluid may be withdrawn from a second container located at a second portion of the tray. The fluid may be added from the second container to the first container. The cap may be installed onto the first container. The cap may be radially compressed with a pair of arms. The first container may be unlocked with respect to the first portion of the tray. The first container may be removed from the first portion of the tray. The cap may be axially compressed with a pair of arms. All or portions of these steps may be performed by a user or may be automated.

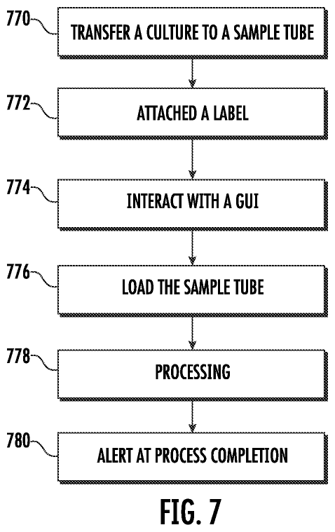

With reference to FIG. 7, an embodiment of a method of a user interacting with a system described herein is illustrated. A user transfers 770 a culture, e.g., an aliquot of positive blood culture. An accession barcode label is attached 772 to the sample tube and an associated barcode label may be attached to one or more other tubes, e.g., a final product tube, one or more tubes of a single use consumable kit or the like. The user interacts 774 with a graphical user interface (GUI) to inform the software and/or the system that a sample tube will be loaded into the system. The tray is unlocked, and the user loads 776 the sample tube and possibly additional tubes to the tray. The system processes 778 the sample tube(s) as described in embodiments herein. The system alerts 780 the user at process completion and may provide a countdown timer for sample tube unloading. A timer may be useful for follow-on susceptibility testing to maintain microorganism viability.

In various system embodiments described herein, the system may be suitable for preparing microorganism suspensions from positive blood cultures. Systems may include a centrifuge capable of spinning samples up to about 2,300 g. Systems may include an automated liquid handler with disposable pipette tips capable of adding and removing fluids. Systems may include one or more arms (e.g., “a gripper”) capable of manipulating, holding, moving, assembling, disassembling, and/or releasing sample tubes, containers, and/or caps. Systems may include a processing station including a clamping mechanism that allows the sample tube(s) to be firmly held during liquid handling or sample tube manipulation. Systems may include a three-axis gantry capable of enabling the liquid handler and gripper to access all points on a tray for processing. Systems may combine the liquid handler and gripper onto a single gantry, each with an individually addressable z-axis linear actuator. An exemplary gantry of a system may include a Festo EXCM-30 planar gantry and a Festo Linear Actuator EGSC-BS.

In various embodiments, a centrifuge may spin samples at angles less than normal to an axis of rotation. In various embodiments, a first centrifugation may be performed at an angle of 30° to the axis of rotation for, e.g., producing a microbial pellet that is radially offset within a tube. The offset pellet may allow an aspirator tip to axially enter the tube substantially along a central axis of the tube to the bottom of the tube without contacting the microbial pellet, which may be advantageous for removing a supernatant. The first centrifugation may be performed at an angle of about 30°, about 60°, about 90°, or any other angle about less than 90° to the axis of rotation. In some embodiments, the centrifuge is capable of performing a 30° centrifugation and, optionally, a 60° centrifugation.

In various embodiments, a system may include a swinging bucket design centrifuge to maximize compatibility with a gantry. Such a centrifuge may rest substantially parallel with the axis of rotation so that a sample tube may be removed by a robotic gripper moving along its z-axis (i.e., perpendicular to the gantry). A centrifuge may include a computer-controlled variable braking system that may assist with reducing undesirable agitation of a sample tube. A centrifuge may be capable of achieving at least two set speeds, e.g., about 500 g and about 1,750 g. An exemplary centrifuge is a Mikro Robotic 220 from Hettich Gmbh, with a custom bucket designed for centrifugation at 30° to the axis of rotation.

In various embodiments, a liquid handler may be capable of removing substantially all liquid from a tube above a set height for maximal supernatant removal while maintaining one or more pelleted microbes. This may require multiple transfer steps with the liquid handler. A liquid handler may be capable of removing a set volume of sample, which may be a fluid or a mixture of fluid and non-fluid. A supernatant may be removed in two steps following microbe pelleting by centrifugation. Firstly, a disposable tip affixed to the liquid handler may detect the liquid height within a tube, and the handler may plunge to a height of, e.g., at least 1 mm, or at least 2.5 mm, or the like below the top of the fluid level. Liquid may be removed until the remaining volume is less than half the volume of the handler pipette tip, which may require multiple transfer steps depending on pipette tip volume and supernatant volume. A tip may be plunged to the lowest depth of a tube and a set volume may be removed. This volume setting may be set to be greater than the volume of fluid remining in the tube to ensure substantially complete removal. Liquid handlers may include level detection capability such as liquid level detection (LLD) that may be capacitive (cLLD) or pressure based (pLLD). A pipettor may have clog detection capabilities.

In various embodiments, a liquid handler may be selected such that microbial pellets may be suspended or resuspended without off-axis orbital shaking or “vortexing.” The pipettor may be capable of delivering at least about 100-2000 μL of fluid at up to about 5-30 mL/sec, about 10-20 mL/sec, or the like, and performing repeated dispense/uptake cycles of at least about 500 μL. The pipettor may first inject about 1 mL of fluid at about 1 mL/sec to a tube, followed by three cycles of removing up to about 1 mL (e.g., about 800 μLf or the like) of fluid from the tube followed by injecting the up to about 1 mL (e.g., about 800 μL or the like) of fluid back into the tube at about 16 mL/sec. An exemplary pipettor includes the Hamilton Zeus pipettor.

In various embodiments, a gripper and a pipettor may share a single x-y-gantry and have separate and individually addressable z-axis actuation. Such a setup may be advantageous for limiting device complexity and size while maintaining required functionality and/or parameters. An automated pipettor may include an integrated z-axis actuator and automatic pipette tip ejector.

In various embodiments, a system may be designed to minimize a spatial footprint, e.g., within about a 24-inch width, by about a 34-inch height, and by about a 28-inch depth. To assist with achieving this spatial footprint, a system may exclude an on-board waste receptacle. Instead, the system may produce waste for removal in each per-sample consumable. A cavity into which the sample tube was loaded into may doubly serve as a waste receptacle. Thus, when the sample tube is unloaded, e.g., after processing with a prepared microbial suspension, the user may also discard waste associated with that sample tube.

In various embodiments, a system may utilize a combination of bulk reagents, that may be shared across multiple samples, and per-sample single use reagents and auxiliary tubes stored in a user-loaded cartridge, which may be inserted and removed independently or together for processing. This may be advantageous to minimize the size of the reagent pack inserted with each sample while providing sufficient reagent for dynamic dilutions to be performed that are useful for providing a microbial suspension within a defined range. For example, a bulk reservoir comprising saline may be utilized, which may be sufficient to provide saline for processing a minimum of 5 samples, 10 samples, 15 samples, 20 samples, 100 samples, or the like. Additionally, a bulk reservoir comprising lytic reagent may be utilized, which is sufficient to provide lytic reagent for processing a minimum of 5 samples, 10 samples, 15 samples, 20 samples, 100 samples, or the like. Bulk pipette tip racks comprising pipette tips may be utilized, which may be sufficient to provide disposable tips for processing a minimum of 5 samples, 10 samples, 15 samples, 20 samples, 100 samples, or the like. Disposable tubes and caps may be added on a per-use basis. In various embodiments, multiple sample tubes, such as an input tube and an output tube may be loaded onto a tray separated from other per-use consumables on the tray. Alternatively, tube reagents could be loaded as bulk consumables and utilized for processing multiple samples.

In various embodiments, a microprocessor (e.g., embedded Windows IoT or Linux computer) may control at least portions of a system. A hierarchical architecture involving microcontrollers may be included, wherein multiple portions are (e.g., a gantry controller, liquid a handler controller, or the like). Inventory management software may be utilized to monitor availability of reagents, consumables, and/or tubes. A microprocessor may check for errors, initiate correction or notify a user of processing failures.

In various embodiments, a system process may include a dynamic dilution, such that the system output may be a microorganism suspension of about 5×10⁶ to about 5×10⁹ CFU/mL and otherwise the system outputs an error message indicating there are insufficient microbes to prepare such a suspension. The microorganism content may be approximated optically via readings at one or more wavelengths between about 500 nm to about 700 nm, between about 550 to about 650 nm, or the like. Exemplary spectrophotometers for taking such measurements may include the Ocean Optics PixelTEQ sensor and the Biosan DEN-1. Nephelometers may also be utilized. Following final centrifugation and supernatant removal, a microbial pellet may be resuspended in about 0.2 mL to about 2 mL of saline, which may also comprise one or more surfactants. A spectrophotometer measurement of this microbial suspension may be measured and compared against a known database. The database may include various bacteria that may be divided by Gram type. In the latter case, the user interface may request the user to enter Gram type information for the sample. The system may calculate the proper amount of saline to add to achieve about 5×10⁶ CFU/mL to about 5×10⁹ CFU/mL. The pipettor may inject this amount of saline into the sample tube and pipette up-and-down at least one time for mixing. A second spectrophotometer reading may follow the saline additive. Data collected from the system may be compared within a database and add more solution via the same process if desirable.

In various embodiments, a system may include a barcode reader. A reader may scan labels on sample tubes (e.g., input and/or output tubes) and send related information to a central processor, which may be a computer of the system or a separate computer interfaced with the system, to validate the order(s) for processing. In alternative embodiments, one or more cameras may additionally or alternatively be utilized as barcode readers.

In various embodiments, a system may be connected to a local area network (LAN) of a clinical laboratory (e.g., ethernet) and may be configured to receive and send data. A server connected to the same network may be configured to receive, send, and store data from the system and other microbiology diagnostic systems (e.g., systems for microorganism identification and antimicrobial susceptibility testing) and the laboratory information system. This configuration allows controlling software on the server to maintain the chain of custody of the samples entering various instruments and to provide necessary information about the sample (e.g., patient demographics, particular test results, etc.) when requested either by a user or other system. A system may interrogate the server about the sample when an associated barcode is scanned (e.g., an automatically initiated query) and may send information (e.g., a time stamp when a sample process is completed) once certain conditions are reached (e.g., sample process completion or failure). The information generated by the system or provided by the server may be displayed for the user via a UI. Information entered or requested by the user via the UI may be transmitted to the server.

### EXAMPLE

A system for sample tube processing was tested for performance in comparison with a commercial SepsiTyper kit and a manual method comprising the same key processing steps outlined in the flow chart in FIG. 7. Aerobic media Bactec sample tubes (Becton-Dickinson) were spiked with 101 CFU of clinical isolates of Staphylococcus aureus. The sample tubes were loaded into a Bactec 9050 continuous monitoring system for microbial growth. Upon registering positive growth in the Bactec, the sample tubes were removed from the system. An aliquot of positive sample was removed from the sample tube for quantitative culture. First, 10 μL of this aliquot was diluted with 90 uL of saline and mixed. Eight subsequent 10-fold dilutions were made from this stock mixture. Next, 3 spots of 10 μL of dilution (10⁻³ through 10⁻⁸) were spot plated onto the surface of a blood agar plate (trypic soy agar supplemented with 5% sheep's blood; Hardy Diagnostics). The plates were then incubated at 34 to 35° C. in ambient air or a CO₂ level ≤5% for 18-24 hours. After incubation, the colonies were counted and recorded.

SepsiTyper processing was performed manually following the manufacturer's (Bruker Daltonics) instructions. Following process completion, quantitative culture was performed following the same procedure described above. Results are provided in Table 1 below.

Processing using an automated system was performed by introducing a 9 mL aliquot of positive blood culture sample into an input sample tube for the system. The sample tube was then loaded into the system followed by automated processing. The system was set such that no dilution of the output sample was performed within the system so complete bacterial retention could be determined. Following process completion, a quantitative culture was performed following the same procedure described above. Results are provided in Table 1 below.

Manual sample tube processing was also performed as follows. A 9 mL aliquot of positive blood culture sample was added to a centrifuge tube and a first centrifugation at 500 g was performed. The supernatant, having a volume of 6.5 mL, was then transferred to a clean tube and a lysis buffer comprising 3% Saponin, 1.53% Sodium Polyanethole Sulfonate, 8×10⁻⁶% Polypropylene Glycol [4000 Mn] was added. A second centrifugation at 1,750 g at a 30° angle was then performed followed by removal of the supernatant by pipetting. A wash was performed by adding 1 mL of saline to the tube followed by a third centrifugation at the same speed and angle. The supernatant was again removed by pipetting and the resulting pellet was resuspended in saline. Quantitative culture was then performed on this suspension following the same procedure described above. Results of these methods of processed bacteria are provided in Table 1 below.

TABLE 1

| | CFU count directly from | CFU count following |
|---|---|---|
| Process | positive blood culture | processing |
| SepsiTyper | 6 × 10⁷ | 0 × 10 |
| Automated System | 4 × 10⁸ | 1.9 × 10⁹ |
| Manual Processing | 4 × 10⁸ | 1.1 × 10⁹ |
| (emulating System) | | |

All of the devices, systems, and methods disclosed and claimed herein can be made and executed without undue experimentation in light of the present disclosure. While the devices and methods of this disclosure have been described in terms of preferred embodiments, it may be apparent to those of skill in the art that variations can be applied to the devices and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A sample tube comprising:
a container comprising an open first end, a closed second end, and a tubular wall extending substantially along a longitudinal axis of the container;
a protrusion extending radially from an external surface of the tubular wall; and
a cap reversibly coupled to the first end of the container, the cap comprising:
an interface ring having a top side, an underside, and a central axis therethrough;
a skirt portion extending from the underside substantially parallel with the central axis, the skirt portion having an outer diameter smaller than an outer diameter of the interface ring;
a sealing wall extending from the underside, the sealing wall being radially within the skirt portion and the sealing wall extending through the central axis; and
a channel between the skirt portion and the sealing wall configured to reversibly accept the tubular wall.

2. The sample tube of claim 1, wherein the sealing wall further comprises:
a first portion extending from the underside of the interface ring substantially parallel with the central axis;
a second portion extending from the first portion away from the underside to a bend extending radially toward the central axis and extending toward the underside;
a third portion extending from the bend toward the interface ring and extending substantially transverse with the central axis thereby forming a cavity radially within the sealing wall coincident with the central axis.

3. The sample tube of claim 2, wherein the first portion of the sealing wall engages an inner surface of the tubular wall when the cap is coupled to the container such that a substantially airtight seal is formed between the sealing wall and the tubular wall.

4. The sample tube of claim 1, wherein the channel extends into the interface ring toward the top side of the interface ring.

5. The sample tube of claim 1, wherein the skirt portion has a radially flared end having an outer diameter larger than a remainder of the skirt portion.

6. The sample tube of claim 1, wherein the top side of the interface ring further comprises:
an outer ring portion; and
an inner ring portion radially internal to the outer ring portion, the internal ring portion coupled to the outer ring portion by a plurality of ribs arrayed about the central axis.

7. The sample tube of claim 1, further comprising a lifting surface on the underside of the interface ring that is substantially transverse with the central axis and is disposed radially external to the skirt portion.

8. A sample tube manipulation system, comprising:
a tray comprising a tray plane and a sample cavity extending normal to the tray plane;
a plate extending substantially parallel with the tray plane, the plate moveable between an unlocked configuration and a locked configuration;
a sample tube comprising a container having a protrusion extending radially from an external surface of a tubular wall of the container and a cap reversibly coupled to an open end of the container, the sample tube configured to be reversibly disposed within the sample cavity; and
a pair of arms each having a first end and a second end, the pair of arms configured to reversibly engage the cap, each arm comprising a cavity, each cavity comprising a first radial surface substantially matching a radius of the cap, and each arm comprising a substantially radially extending finger at the second end of the arm.

9. The system of claim 8, wherein the first radial surface interfaces with an outer surface of the cap and the finger interfaces with an underside of the cap when each of the arms are in an engaged configuration.

10. The system of any of claim 8, wherein the protrusion has an outer diameter larger than a diameter of the sample cavity, and wherein when the sample tube is disposed within the sample cavity and the plate is in the locked configuration, the plate is disposed between the protrusion and an open end of the container.

11. The system of any of claim 8, wherein when the pair of arms are engaged with the cap, the cap is radially compressed against the tubular wall such that moving the pair of arms substantially normal to the tray plane while engaging the cap translates the entirety of the sample tube.

12. The system of any of claim 8, wherein the cavity of each of the pair of arms comprises a first portion at the first radial surface, the first portion comprising a height that is at least 50% larger than a height of an interface ring of the cap.

13. The system of claim 12, wherein the first portion further comprises a substantially transverse surface defining an end of the first portion that is towards the first end of each arm, the transverse surface configured to interface with at least a portion of a top surface of the cap.

14. The system of any of claim 8, wherein the cap and container of the sample are configured to reversibly couple to each other via movement of the pair of arms normal to the tray plane when the pair of arms are engaged with the cap, the sample tube is disposed within the sample cavity, and the plate is in the locked configuration.

15. The system of any of claim 8, wherein the cavity of each arm further comprises a second radial surface disposed adjacent to the first radial surface, the second radial surface having a radius that is different than the radius of the cap.
